(19) United States
(12) Patent Application Publication
(10) Pub. No.: US 2024/0154808 A1
(43) Pub. Date: May 9, 2024

(54) SYSTEMS AND METHODS OF TRACE ID VALIDATION AND TRUST

(71) Applicant: Change Healthcare Holdings, LLC, Nashville, TN (US)

(72) Inventors: Thomas Cosley, Guttenberg, IA (US); Chris Compton, Fort Worth, TX (US)

(21) Appl. No.: 17/980,116

(22) Filed: Nov. 3, 2022

(51) Int. Cl. H04L 9/32; H04L 9/08

(52) U.S. Cl. CPC H04L 9/3213; H04L 9/0825; H04L 9/3242

(57) ABSTRACT

An example transaction processing system and method are disclosed that employ validating a trace identifier (“trace ID”) of a calling service by a recipient service. In particular, systems and methods are provided such that application programing interface (API) calls to a clearinghouse can be validated and trusted and the trusted trace ID can be used in transactions by the clearinghouse to other entities involving the call to the clearinghouse.

### FIELD OF THE INVENTION

Embodiments of the present invention relate generally to systems and methods of validating a trace identifier (“trace ID”) of a calling service by a recipient service. In particular, systems and methods are provided such that application programing interface (API) calls to a clearinghouse can be validated and trusted and the trusted trace ID can be used in transactions by the clearinghouse to other entities involving the call to the clearinghouse. In this way, transactions can be traced from the calling service to the clearinghouse and from the clearinghouse to one or more third-parties, and vice-versa.

### BACKGROUND

There is a commercial benefit to automating and streamlining the review and approval process for healthcare transactions including transactions related to eligibility, coverage for a certain procedure or treatment, status of a claim, prior authorization for a procedure or treatment, and the like. Such transactions may be related to claims from a healthcare provider to a payor (insurance company, government entity, etc.), including medical, dental, or vision claims.

Typical network applications are orchestrations of API based services owned by disparate delivery teams. This structure makes it difficult to trace activities when a given transaction spans many services. To enable tracing, a trace ID (v4 UUID, for example) is provided as a means of correlating activities in access and application logs. Such a trace ID can be propagated from one service to another in a flow (for example, in an http header, x-trace-id). However, upon receipt of such a header, the recipient service cannot validate the integrity of the calling service's trace ID and verify that it is unique, that it hasn't been tampered with, etc.

Generally, a provider system creates a transaction with a provider-created trace ID that they send to a clearinghouse. Typically, the clearinghouse doesn't trust the provider-created trace ID, so it creates its own and swaps it out before sending to a third party such as a payor, another clearinghouse, or some other service provider, each of whom may similarly create its own trace ID. As such, there is no way for the payor or provider to ask about the status of the transaction (because neither knows what the ID is at the point in time when they are asking, since it depends on what hop the transaction is on in its route).

Therefore, systems, methods and computer program products are needed that overcome challenges in the art, some of which are described above.

### BRIEF SUMMARY

In one aspect, a method for trace identifier (ID) validation and trust is disclosed. One embodiment of the method comprises receiving, by a receiving party, from a calling service, a first transaction having a first transaction trace ID. The receiving party validates the received first transaction trace ID and determines that it is trusted. The receiving party then performs a second transaction with a third-party. The second transaction is related to the first transaction, and the validated first transaction trace ID is used as a second transaction trace ID for the second transaction. As such, the first transaction trace ID can be determined from the second transaction trace ID, the second transaction trace ID can be determined from the first transaction trace ID, and the calling service is a different party than the third-party.

In some instances of the method, receiving, by the receiving party, from the calling service, the first transaction having the first transaction trace ID comprises the calling service including a verifiable token in its first transaction trace ID. For example, the verifiable token may comprise a HMAC (Hash-Based Message Authentication Code).

In some instances of the method, the calling service generates a universally unique identifier (UUID); and generates the HMAC using the UUID salted with a salt value appended or prepended to the UUID as an input to a hashing algorithm. For example, the hashing algorithm may comprise secure hashing algorithm (SHA) 256, and the salt value may be unique to each transaction between the calling service and the receiving party.

In some instances of the method, the calling service shares at least the UUID and an identification of the hashing algorithm with the receiving party.

In some instances of the method, validating, by the receiving party, the received first transaction trace ID and determining that it is trusted comprises the receiving party running the UUID appended or prepended with the salt value through the identified hashing algorithm and an outcome of the receiving party's salt and hashing is compared to the HMAC, where if the outcome matches the HMAC, then the UUID is validated and trusted as the first transaction trace ID.

In some instances of the method, performing, by the receiving party, the second transaction by the receiving party with the third-party, wherein the second transaction is related to the first transaction, and wherein the validated first transaction trace ID is used as the second transaction trace ID for the second transaction comprises sharing the HMAC, the UUID, and the identification of the hashing algorithm with the third party, and the third party receiving the second transaction trace ID and determining that it is trusted comprises the third party running the UUID appended or prepended with the salt value through the identified hashing algorithm and an outcome of the third party's salt and hashing is compared to the HMAC, wherein if the outcome matches the HMAC, then the UUID is validated and trusted as the second transaction trace ID.

In some instances of the method, the verifiable token comprises an encrypted public key infrastructure (PKI) certificate that comprises the first transaction trace ID. In such instances, validating, by the receiving party, the received first transaction trace ID and determining that it is trusted comprises the receiving party decrypting the PKI certificate using its public key provided by the calling service. A successful decryption of the PKI certificate by the receiving party using the public key provided by the calling service authenticates and validates the received first transaction trace ID. Also, in such instances, the decrypted PKI certificate may be re-encrypted by the receiving party and used as the second transaction trace ID for the second transaction. The third party decrypts the re-encrypted PKI certificate using a public key provided by the receiving party. A successful decryption of the PKI certificate by the third party using the public key provided by the receiving party authenticates and validates the received second transaction trace ID. The public key used by the third party may be the same public key used by the receiving party, or may be a new public key from a private key/public key set used by the receiving party to encrypt the PKI certificate prior to sending it with the second transaction to the third party.

In another aspect, a system for trace identifier (ID) validation and trust is disclosed. One embodiment of the system comprises at least one computing device comprising a processor and a memory, the memory having instructions stored thereon that when executed by the processor cause the at least one computing device to perform a plurality of operations, wherein the plurality of operations include: receiving, by the processor, from a calling service, a first transaction having a first transaction trace ID; validating, by the processor, the received first transaction trace ID and determining that it is trusted; performing, by the processor, a second transaction with a third-party, wherein the second transaction is related to the first transaction, and wherein the validated first transaction trace ID is used as a second transaction trace ID for the second transaction.

In some instances of the system, the first transaction trace ID can be determined from the second transaction trace ID, the second transaction trace ID can be determined from the first transaction trace ID, and the calling service is a different party than the third-party.

In some instances of the system, receiving, by the processor, from the calling service, the first transaction having the first transaction trace ID comprises the calling service including a verifiable token in its first transaction trace ID. For example, the verifiable token may comprise a HMAC (Hash-Based Message Authentication Code).

In some instances of the system, the calling service generates a universally unique identifier (UUID); and generates the HMAC using the UUID salted with a salt value appended or prepended to the UUID as an input to a hashing algorithm. For example, the hashing algorithm may comprise secure hashing algorithm (SHA) 256, and the salt value is unique to each transaction between the calling service and the processor.

In some instances of the system, the calling service shares at least the UUID and an identification of the hashing algorithm with the processor.

In some instances of the system, validating, by the processor, the received first transaction trace ID and determining that it is trusted comprises the processor running the UUID appended or prepended with the salt value through the identified hashing algorithm and an outcome of the processor's salt and hashing is compared to the HMAC, where if the outcome matches the HMAC, then the UUID is validated and trusted as the first transaction trace ID.

In some instances of the system, performing, by the processor, the second transaction by the processor with the third-party, wherein the second transaction is related to the first transaction, and wherein the validated first transaction trace ID is used as the second transaction trace ID for the second transaction comprises sharing the HMAC, the UUID, the salt value and the identification of the hashing algorithm with the third party, and the third party receiving the second transaction trace ID and determining that it is trusted comprises the third party running the UUID appended or prepended with the salt value through the identified hashing algorithm and an outcome of the third party's salt and hashing is compared to the HMAC, wherein if the outcome matches the HMAC, then the UUID is validated and trusted as the second transaction trace ID.

In some instances of the system, the verifiable token comprises an encrypted public key infrastructure (PKI) certificate that comprises the first transaction trace ID. In such instances, validating, by the processor, the received first transaction trace ID and determining that it is trusted comprises the processor decrypting the PKI certificate using its public key provided by the calling service. A successful decryption of the PKI certificate by the processor using the public key provided by the calling service authenticates and validates the received first transaction trace ID. Also, in such instances, the decrypted PKI certificate may be re-encrypted by the processor and used as the second transaction trace ID for the second transaction. The third party decrypts the re-encrypted PKI certificate using a public key provided by the processor. A successful decryption of the PKI certificate by the third party using the public key provided by the processor authenticates and validates the received second transaction trace ID. The public key used by the third party may be the same public key used by the processor, or may be a new public key from a private key/public key set used by the processor to encrypt the PKI certificate prior to sending it with the second transaction to the third party.

Other objects and advantages will become apparent to the reader, and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 Illustrates an exemplary overview system for performing aspects of the disclosed embodiments.

FIG. 2 is a flowchart illustrating an exemplary method of trace ID validation and trust.

FIGS. 3A and 3B illustrate an exemplary flowchart of a more-detailed version of a trace ID validation and trust method.

FIGS. 3C and 3D illustrate an exemplary flowchart of another more-detailed version of a trace ID validation and trust method.

FIG. 4 shows an example computing environment in which example embodiments and aspects may be implemented.

### DETAILED DESCRIPTION

Before the present methods and systems are disclosed and described, it is to be understood that the methods and systems are not limited to specific synthetic methods, specific components, or to particular compositions. It is also to be understood that the terminology used in this entire application is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, to “about” another particular value, or from “about” one value to “about” another value. When such a range is expressed, another embodiment includes from the one particular value, to the other particular value, or from the one particular value to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

When referring to a claim for payment for health-related services performed by a provider or a transaction, the plural form of “claim” or “transaction” be used for brevity instead of stating “one or more claims” or “one or more transactions.” As such, it is to be appreciated that the plural form of “claim” or “transaction” may refer to one claim or one transaction or a plurality of claims or a plurality of transactions.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, DVD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present methods and systems may be understood more readily by reference to the following detailed description of preferred embodiments and the Examples included therein and to the Figures and their previous and following description.

### Overview

In a typical claim processing workflow for healthcare services (medical, dental, and vision), following providing a service to a patient, a service provider submits a healthcare claim (medical, dental, or vision claim) on behalf of a patient to a payor (e.g., a patient's insurance company, a government entity/program, etc.) for reimbursement. The payor evaluates the claim and either approves the claim, in whole or in part, rejects the claim, or requests for additional information. With many claim types, the payor may require the service provider to submit supporting evidence of the service being performed and the necessity of that treatment, and would then evaluate that information and the claim request in view of the patient's coverage by the insurance policy or governmental entity (medical, dental, or vision). The task is often non-trivial, i.e., time-consuming, and employs a substantial degree of human judgment, namely, to evaluate the validity of a claim and whether the evidentiary support for the claim is sufficient. The payor may also evaluate for fraud or mistakes in the process.

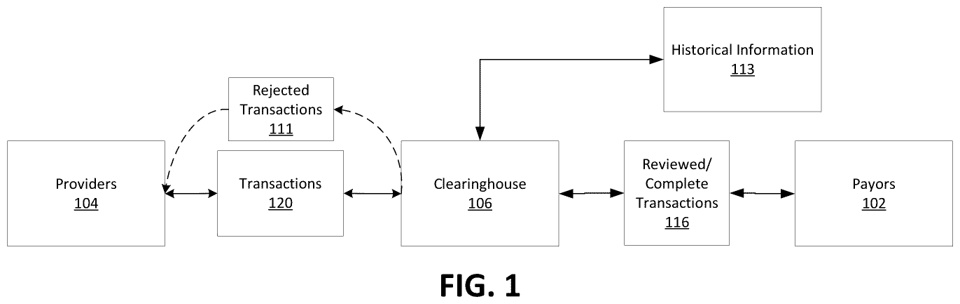

Claim processing also may involve a number of transactions including transactions related to eligibility, coverage for a certain procedure or treatment, status of a claim, prior authorization fora procedure or treatment, and the like. Therefore, as shown in FIG. 1, transactions 120 may be reviewed and analyzed by a clearinghouse 106. The clearinghouse 106 intercepts transactions 120 sent by the provider 104 and reviews those transactions for completeness, accuracy, adherence to provider rules, adherence to payor rules, and the like. As noted herein, such transactions 120 may be related to healthcare claims. In some instances, the clearinghouse 106 may utilize a database of historical information 113 about the patient and/or the providers 104 and/or the payors 102 in its review of transactions 120 to ensure consistency, identify expected, additional, or missing information, and the like. It is to be appreciated that the diagram in FIG. 1 is simplified, in that a single clearinghouse 106 may process transactions associated with a plurality of payors 102 and a plurality of providers 104 such that the clearinghouse 106 may be involved with at least tens of thousands of provider-payor transactions on a daily basis. Similarly, the clearinghouse 106 may comprise a plurality of clearinghouses that conduct transactions between clearinghouses as well as between the providers 104 and payors. As this volume of claim review would be impossible to accomplish manually, the described processes are automated using computing devices and network connections. Furthermore, as used in reference to FIG. 1, a “transaction” comprises inquiries and responses related to patient eligibility, coverage for a certain procedure or treatment, status of a claim, prior authorization for a procedure or treatment, and the like. Transactions may comprise healthcare claims, be related to or a part of a healthcare claim, or be unassociated with healthcare claims. Referring to FIG. 1, transactions may occur between any of the parties—providers 104, payors 102, clearinghouses 106, and/or between those parties and other third-parties such as financial institutions. This includes, but is not limited to, discrete, real-time electronic communications involving the X12 standards for healthcare administrative transactions in compliance with HIPAA requirements.

Transactions 120 reviewed by the clearinghouse 106 that meet requirements are passed on to the designated payors 102 for payment and/or reimbursement to the providers 104 and/or responses to the providers 104 from the payors 102 as reviewed/complete transactions 116. Transactions 111 that require re-work, additional information, etc. are returned by the clearinghouse to the sending provider 104.

As noted above, these processes are almost entirely automated. Typically, calls (i.e., transactions) to a clearinghouse 106, whether from a provider 104 or a payor 102, are performed using an application programing interface (API) over a network. Such transactions include a header with header information, and the header information typically includes a trace ID. However, as noted herein, such trace IDs are generally not trusted by the clearinghouse 106, and the clearinghouse 106 assigns its own trace ID to transactions originating from the clearinghouse 106. This creates a challenge to trace a transaction from its origination, through processing, and to its destination, as conventionally the trace ID typically changes during this process. Described herein are systems, methods and computer program products where the trace ID from a calling service can be validated and trusted and the trusted trace ID can then be used in transactions by the receiving party with other entities involving the call to the receiving party. In this way, transactions can be traced from the calling service to the receiving party and from the receiving party to one or more third-parties, and vice-versa.

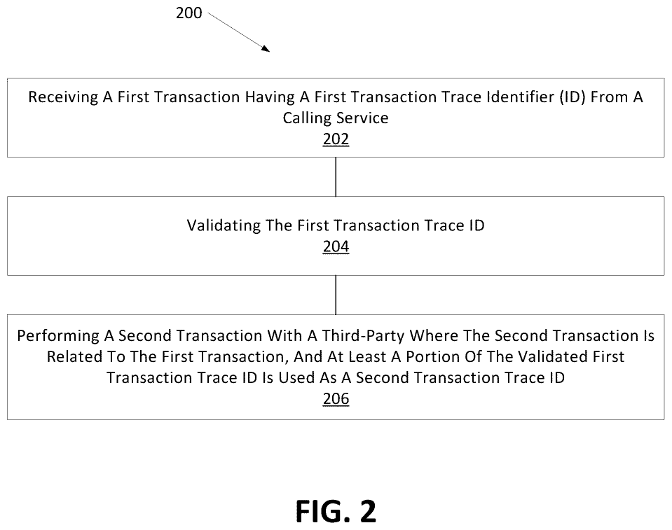

FIG. 2 shows an exemplary method 200 of trace ID validation and trust. The method 200 includes receiving (202), by a receiving party, from a calling service, a first transaction having a first transaction trace identifier (ID). At 204, the received first transaction trace ID is validated and determined by the receiving party to be trusted. At 206, a second transaction is performed by the receiving party with a third-party. The second transaction is related to the first transaction, and the validated first transaction trace ID is used as a second transaction trace ID. As such, the third party can trace the second transaction and the first transaction back to the calling service having knowledge of only the second transaction trace ID. Likewise, the calling service can trace the first transaction and the second transaction to the third-party having knowledge of only the first transaction trace ID.

One example way of accomplishing the above-described method comprises the calling service (e.g., a provider 104, a payor 102, etc.) including a verifiable token in their trace ID. In one example, this can be in the form of a HMAC (Hash-Based Message Authentication Code). For example, the calling service generates a universally unique identifier (UUID) such as x-trace-id: 21887FD1-D9A7-47B5-BBE9-A312A5E93803. The calling service then generates a hash-based message authentication code (HMAC) header using the UUID as an input to the hashing algorithm. For example, the calling service uses secure hashing algorithm (SHA) 256 hashing with a salt of “salty-dog” added to the beginning or the end of the UUID to create the HMAC header. In some instances, the salt value may be unique to each transaction between parties. For example, the salt value may be a separate thing negotiated between a provider 104 (e.g., a calling service) and a clearinghouse 106 (e.g., receiving party), or a payor 102 (e.g., third party) and the clearinghouse 106 (e.g., receiving party), between a first clearinghouse (e.g., a calling service) and a second clearinghouse (e.g., a receiving party), between any of a provider 104 (e.g., a calling service), a clearinghouse 106 (e.g., a receiving party), and/or a payor 102 (e.g., a third party) with any of one or more other third-parties. In yet other instances, the clearinghouse 106 may provide access for a provider 104, payor 102, another clearinghouse, or a third party to obtain a salt value from the clearinghouse 106. Referring back to the above example, using x-trace-id-hmac-alg: SHA256, the x-trace-id prepended with “salty-dog” results in the following x-trace-id-hmac: 91a09354486a9e353113eba7394a46d5b60894e5fca9ea431256dfadd7bc1e58.

The calling service shares the salt value along with the value of x-trace-id-hmac-alg (in this example, SHA256) with the receiving party. In some instances, the salt value may be shared using an additional header such as x-trace-id-salt in the transaction between the calling service and the receiving party. The receiving party runs the UUID x-trace-id through the algorithm identified as the x-trace-id-hmac-alg (e.g., SHA256) with the appended or prepended salt value (e.g., “salty-dog”) to salt and hash the x-trace-id value. The outcome of the receiving party's salt and hashing is compared to the outcome to the x-trace-id-hmac value. If there is a match, then the UUID is validated as a trusted trace ID.

The receiving party could then, in turn, in a second transaction related to the first transaction involving the calling service, share the salt value (e.g., x-trace-id-salt header) and the value of x-trace-id-hmac-alg (in this example, SHA256) with one or more third parties who, in turn, can validate the UUID is validated as a trusted trace ID. In this way, the validated, trusted trace ID (i.e., UUID) can be used to trace the first transaction involving the calling service and any subsequent transactions related to the first transaction as they all share a validated, trusted trace ID.

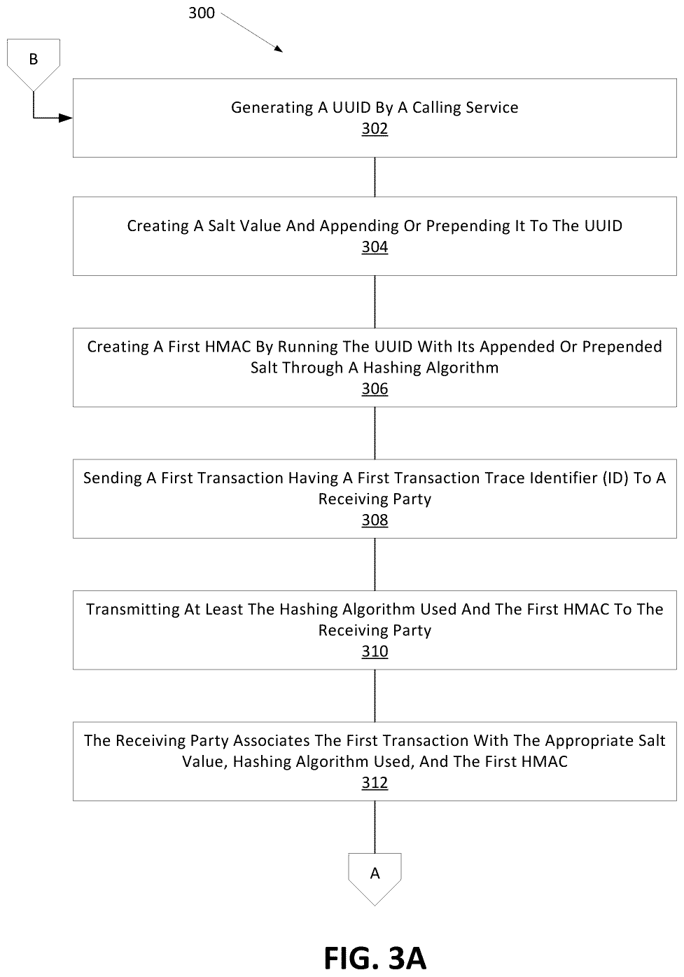

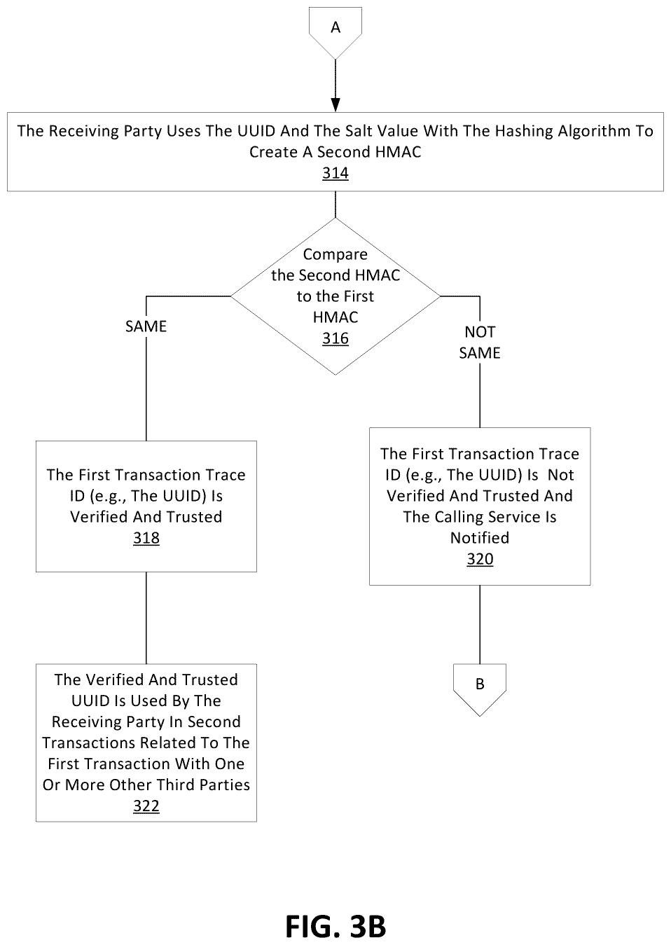

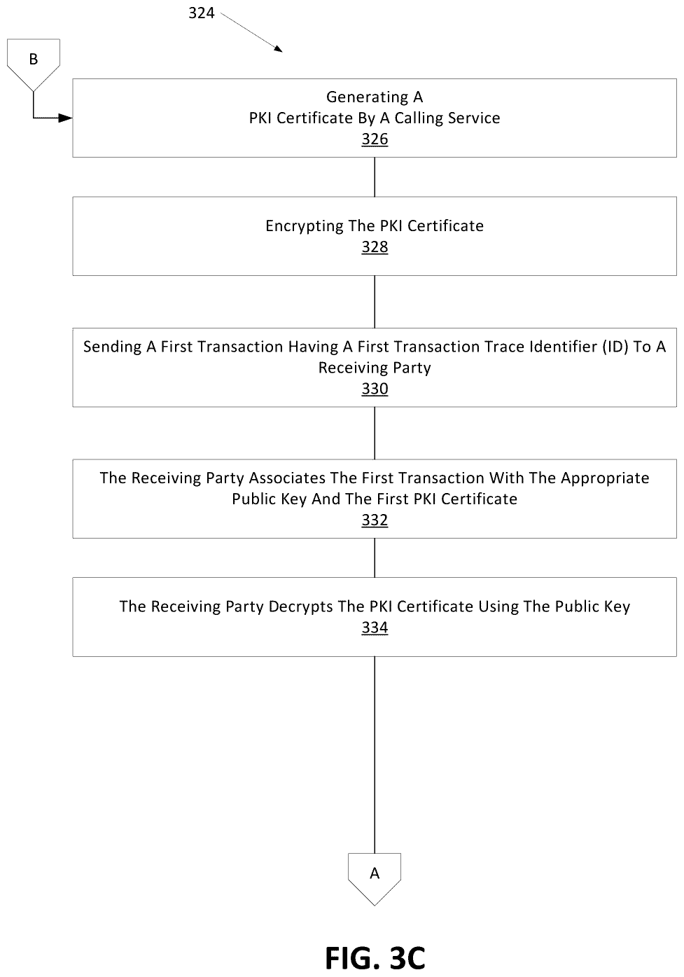

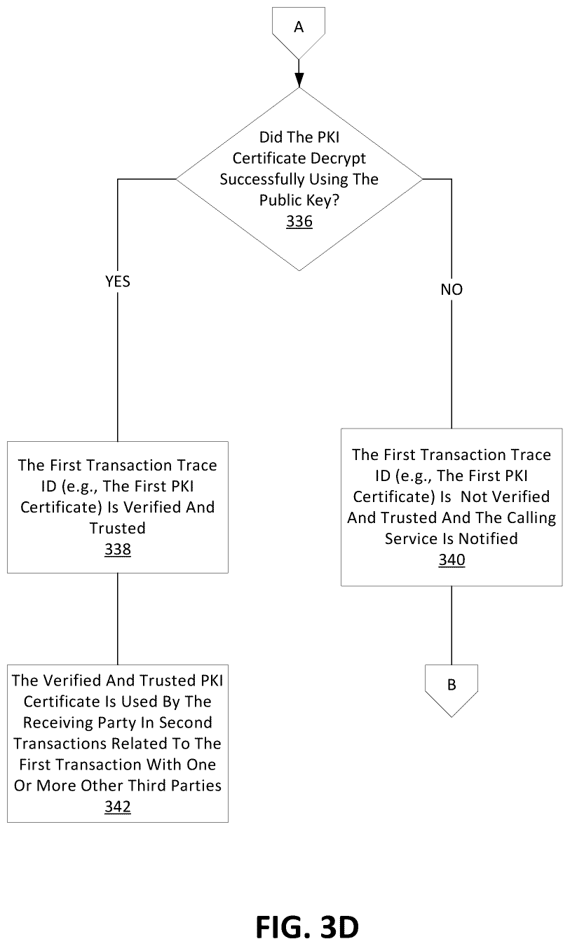

FIGS. 3A and 3B illustrate an exemplary flowchart of a more-detailed version of a trace ID validation and trust method 300. The method 300 comprises (302) the calling service generating a UUID. At 304, the calling service creates a salt value and appends or prepends it to the UUID. At 306, the calling service creates a first HMAC by running the UUID with its appended or prepended salt through a hashing algorithm to arrive at the first HMAC. At 308, the calling service sends a first transaction having a first transaction trace identifier (ID) to a receiving party. The first transaction trace identifier is the UUID generated by the calling service. At 310, the calling service transmits the hashing algorithm used and the first HMAC to the receiving party. This may be transmitted separately from the first transaction or with the first transaction. In some instances, the calling service may also transmit the salt value with this transmission, or separately. For example, it may be transmitted as a header (e.g., x-trace-id-salt) in the transaction between the calling services and the receiving party. In other instances, the receiving party may have created the salt value and may have previously transmitted it to the calling service or otherwise allowed the calling service to obtain it. At 312, the receiving party associates the first transaction with the appropriate salt value, hashing algorithm used, and the first HMAC. At 314, the receiving party uses the UUID and the salt value with the hashing algorithm to create a second HMAC. At 316, the second HMAC is compared to the first HMAC. If, at 316, they are the same, then the first transaction trace ID (e.g., the UUID) is (318) verified and trusted. If, at 316, they are not the same, then the first transaction trace ID (e.g., the UUID) is (320) not verified and trusted, and the calling service is notified. Returning to 318, at 322 the verified and trusted UUID can be used by the receiving party in second transactions related to the first transaction with one or more other third parties, where the second transactions use a second transaction trace ID that is the same as the first transaction trace ID (e.g., the UUID generated by the calling service).

In some instances, the receiving party may transmit the salt value, hashing algorithm used, and the first HMAC to the one or more other third parties so that the one or more third parties can validate the second transaction trace ID. In other instances, the receiving party may establish a different salt value with each third party while using the same HMAC. In such instances, the receiving party may transmit the different salt value, the hashing algorithm used, and the first HMAC to the one or more other third parties so that the one or more third parties can validate the second transaction trace ID. The receiving party may use a different salt value with each third party it transacts with, while using the same HMAC. As such, the one or more third parties can trace the second transaction and the first transaction back to the calling service having knowledge of only the second transaction trace ID. Likewise, the calling service can trace the first transaction and the second transaction to the third-party having knowledge of only the first transaction trace ID. Furthermore, the receiving party can keep track of all related transactions as they all have the same trusted trace ID.

As such, the receiving party can use these systems, methods and computer program products with trading partners; where the receiving party establishes trusted trace-IDs across trading partner boundaries and provides trading partners with a self-service means of managing the shared-secret/salt and algorithms that ingress endpoints of the receiving party (public APIs) would use to validate/trust their UUID and use them throughout processing within the receiving party's system of services.

Though the aforementioned example describes using the SHA256 hashing algorithm, it is to be appreciated the other forms of shared-secret encryption can be used including for example, public key infrastructure (PKI) using client-specific certificates, any form of encrypted digital signature, and the like.

For example, FIG. 3C is a flowchart of another trace ID validation and trust method 324. The method 324 comprises (326) the calling service generating a first PKI certificate. The first PKI certificate has a private key and a public key. At 328, the calling service encrypts the first PKI certificate using its private key. At 330, the calling service sends a first transaction having a first transaction trace identifier (ID) to a receiving party. The first transaction trace identifier is the encrypted first PKI certificate generated by the calling service. Typically, the public key is either sent with the first transaction or sent separately from the calling service to the receiving party. For example, the first PKI certificate (and possibly the public key, too) may be transmitted as a header (e.g., x-trace-id-salt) in the transaction between the calling services and the receiving party. In other instances, the receiving party may have created the first PKI certificate (and its private and public keys) and may have previously transmitted it to the calling service or otherwise allowed the calling service to obtain it. At 332, the receiving party associates the first transaction with the appropriate public key and the first PKI certificate. At 334, the receiving party decrypts the first PKI certificate using the public key. At 336, it is determined whether the first PKI certificate decrypts successfully using the public key. If, at 336, the PKI certificate does successfully decrypt using the public key, then the first transaction trace ID (e.g., the first PKI certificate) is (338) verified and trusted. If, at 336, the first PKI certificate does not decrypt successfully using the public key (indicating tampering or modification during transmission), then the first transaction trace ID (e.g., the first PKI certificate) is (340) not verified and trusted, and the calling service is notified.

Returning to 338, at 342 the verified and trusted first PKI certificate can be used by the receiving party in second transactions related to the first transaction with one or more other third parties, where the second transactions use a second transaction trace ID that is the same as the first transaction trace ID (e.g., the first PKI certificate generated by the calling service). In some instances, the receiving party may transmit the public key and the first PKI certificate to the one or more other third parties so that the one or more third parties can validate the second transaction trace ID. In other instances, the receiving party may establish a different private key and public key for the first PKI certificate (however, the unencrypted or decrypted first PKI certificate used in the second transactions has the same value as the unencrypted or decrypted first PKI certificates used in the first transactions). In such instances, the receiving party may transmit the different public key and the first digital certificate to the one or more other third parties so that the one or more third parties can validate the second transaction trace ID. The receiving party may use a different private key/public key pair with each third party it transacts with, while using the same first PKI certificate. As such, the one or more third parties can trace the second transaction and the first transaction back to the calling service having knowledge of only the second transaction trace ID (the decrypted first PKI certificate). Likewise, the calling service can trace the first transaction and the second transaction to the third-party having knowledge of only the first transaction trace ID (also the decrypted first PKI certificate). Furthermore, the receiving party can keep track of all related transactions as they all have the same trusted trace ID.

The disclosed systems, methods and computer program products can be implemented in a healthcare claims processing environment. It is to be noted that in the healthcare claims processing environment illustrated in FIG. 1, the calling service will generally be a provider 104, the receiving party will generally be the clearinghouse 106, the third party will be the payors 102, and the transactions are generally healthcare claims or transactions associated with healthcare claims, though other implementations and environments are contemplated within the scope of this disclosure and the claims of this application. For example, embodiments disclosed herein may be utilized in a real-time network for eligibility, claim status, prior authorization, and the like that typically involves HTTPS request/reply interactions among partners (where extra headers can be carried).

### Computing Environment

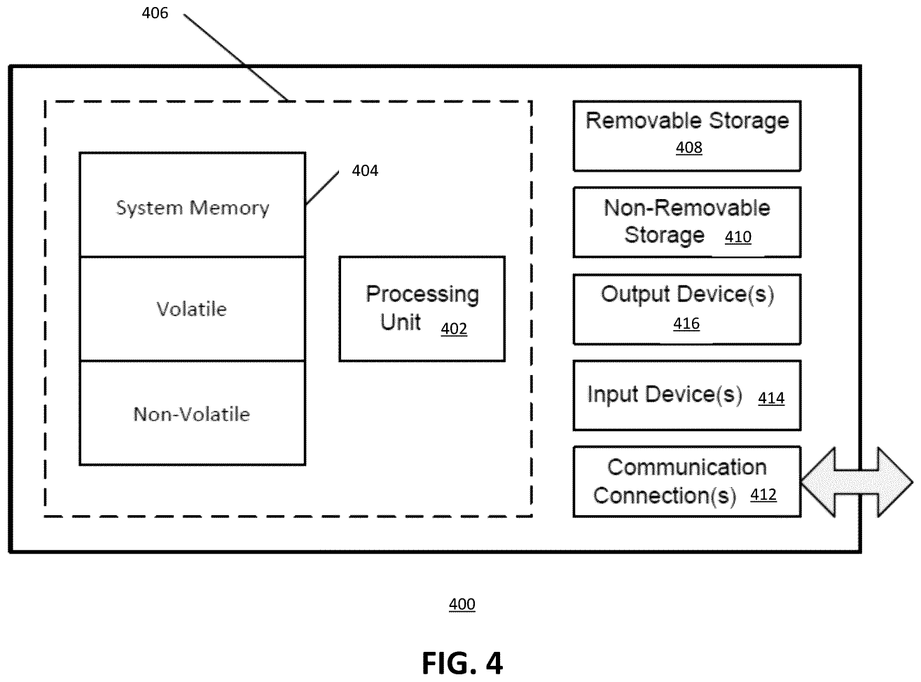

FIG. 4 shows an example computing environment in which example embodiments and aspects may be implemented. The computing device environment is only one example of a suitable computing environment and is not intended to suggest any limitation as to the scope of use or functionality. The computing environment of FIG. 4 may be a computing device 400 used by a provider 104, a clearinghouse 106, and/or a payor 102. In various implementations, computing devices 400 used by the various parties may be interconnected with one another through networks. Such networks may be wired (including fiber optic), wireless, or combinations thereof.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, cloud-based systems, microprocessor-based systems, network personal computers (PCs), minicomputers, mainframe computers, embedded systems, distributed computing environments that include any of the above systems or devices, and the like. The computing environment may include a cloud-based computing environment.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an example system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random-access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by computing device 400. Any such computer storage media may be part of computing device 400.

Computing device 400 may contain communication connection(s) 412 that allow the device to communicate with other devices over networks. Such networks may be public or private, and may include the internet. Computing device 400 may also have input device(s) 414 such as a keyboard, mouse, pen, voice input device, touch input device, etc. Output device(s) 416 such as a display, speakers, printer, etc. may also be included. All these devices are well

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for trace identifier (ID) validation and trust, said method comprises:
receiving, by a receiving party, from a calling service, a first transaction having a first transaction trace ID;
validating, by the receiving party, the received first transaction trace ID and determining that it is trusted;
performing, by the receiving party, a second transaction by the receiving party with a third-party, wherein the second transaction is related to the first transaction, and wherein the validated first transaction trace ID is used as a second transaction trace ID for the second transaction.

2. The method of claim 1, wherein receiving, by the receiving party, from the calling service, the first transaction having the first transaction trace ID comprises the calling service including a verifiable token in its first transaction trace ID.

3. The method of claim 2, wherein the verifiable token comprises a HMAC (Hash-Based Message Authentication Code).

4. The method of claim 3, wherein the calling service generates a universally unique identifier (UUID); and generates the HMAC using the UUID salted with a salt value appended or prepended to the UUID as an input to a hashing algorithm.

5. The method of claim 4, wherein the hashing algorithm comprises secure hashing algorithm (SHA) 256, and wherein the salt value is unique to transactions between the calling service and the receiving party.

6. The method of claim 5, wherein the calling service shares the UUID and an identification of the hashing algorithm with the receiving party.

7. The method of claim 6, wherein validating, by the receiving party, the received first transaction trace ID and determining that it is trusted comprises the receiving party running the UUID appended or prepended with the salt value through the identified hashing algorithm and an outcome of the receiving party's salt and hashing is compared to the HMAC, wherein if the outcome matches the HMAC, then the UUID is validated and trusted as the first transaction trace ID.

8. The method of claim 7, wherein performing, by the receiving party, the second transaction by the receiving party with the third-party, wherein the second transaction is related to the first transaction, and wherein the validated first transaction trace ID is used as the second transaction trace ID for the second transaction comprises sharing the HMAC, the UUID, and the identification of the hashing algorithm with the third party, and the third party receiving the second transaction trace ID and determining that it is trusted comprises the third party running the UUID appended or prepended with a second salt value through the identified hashing algorithm and an outcome of the third party's salt and hashing is compared to the HMAC, wherein if the outcome matches the HMAC, then the UUID is validated and trusted as the second transaction trace ID.

9. The method of claim 2, wherein the verifiable token comprises an encrypted public key infrastructure (PKI) certificate, said encrypted PKI certificate comprising the first transaction trace ID, wherein the PKI certificate is decrypted by the receiving party using a public key provided by the calling service, wherein successful decryption of the PKI certificate by the receiving party using the public key provided by the calling service authenticates and validates the received first transaction trace ID.

10. The method of claim 9, wherein the decrypted PKI certificate is re-encrypted by the receiving party and used as the second transaction trace ID for the second transaction, wherein the third party decrypts the re-encrypted PKI certificate using a public key provided by the receiving party, wherein successful decryption of the PKI certificate by the third party using the public key provided by the receiving party authenticates and validates the received second transaction trace ID.

11. A system for trace identifier (ID) validation and trust comprising:
at least one computing device comprising a processor and a memory, said memory having instructions stored thereon that when executed by the processor cause the at least one computing device to perform a plurality of operations, wherein the plurality of operations include:
receiving, by the processor, from a calling service, a first transaction having a first transaction trace ID;
validating, by the processor, the received first transaction trace ID and determining that it is trusted;
performing, by the processor, a second transaction with a third-party, wherein the second transaction is related to the first transaction, and wherein the validated first transaction trace ID is used as a second transaction trace ID for the second transaction.

12. The system of claim 11, wherein receiving, by the processor, from the calling service, the first transaction having the first transaction trace ID comprises the calling service including a verifiable token in its first transaction trace ID.

13. The system of claim 12, wherein the verifiable token comprises a HMAC (Hash-Based Message Authentication Code).

14. The system of claim 13, wherein the calling service generates a universally unique identifier (UUID); and generates the HMAC using the UUID salted with a salt value appended or prepended to the UUID as an input to a hashing algorithm.

15. The system of claim 14, wherein the hashing algorithm comprises secure hashing algorithm (SHA) 256, and wherein the salt value is unique to transactions between the calling service and the processor.

16. The system of claim 15, wherein the calling service shares at least the UUID and an identification of the hashing algorithm with the processor.

17. The system of claim 16, wherein validating, by the processor, the received first transaction trace ID and determining that it is trusted comprises the processor running the UUID appended or prepended with the salt value through the identified hashing algorithm and an outcome of the processor's salt and hashing is compared to the HMAC, wherein if the outcome matches the HMAC, then the UUID is validated and trusted as the first transaction trace ID.

18. The system of claim 17, wherein performing, by the processor, the second transaction by the processor with the third-party, wherein the second transaction is related to the first transaction, and wherein the validated first transaction trace ID is used as the second transaction trace ID for the second transaction comprises sharing the HMAC, the UUID, and the identification of the hashing algorithm with the third party, and the third party receiving the second transaction trace ID and determining that it is trusted comprises the third party running the UUID appended or prepended with a second salt value through the identified hashing algorithm and an outcome of the third party's salt and hashing is compared to the HMAC, wherein if the outcome matches the HMAC, then the UUID is validated and trusted as the second transaction trace ID.

19. The system of claim 12, wherein the verifiable token comprises an encrypted public key infrastructure (PKI) certificate, said encrypted PKI certificate comprising the first transaction trace ID, wherein the PKI certificate is decrypted by the processor using a public key provided by the calling service, wherein successful decryption of the PKI certificate by the processor using the public key provided by the calling service authenticates and validates the received first transaction trace ID.

20. The system of claim 19, wherein the decrypted PKI certificate is re-encrypted by the processor and used as the second transaction trace ID for the second transaction, wherein the third party decrypts the re-encrypted PKI certificate using a public key provided by the processor, wherein successful decryption of the PKI certificate by the third party using the public key provided by the processor authenticates and validates the received second transaction trace ID.
